(19) United States
(12) Patent Application Publication
(10) Pub. No.: US 2005/0133078 A1
(43) Pub. Date: Jun. 23, 2005

(54) Hand-gripped device for assistance in lowering to and rising from a seated position

(76) Inventor: William S. Fujitsubo, Corona del Mar, CA (US)

Correspondence Address: HOWARD J. GREENWALD P.C., 349 W. COMMERCIAL STREET SUITE 2490, EAST ROCHESTER, NY, 14445-2408, US

(21) Appl. No.: 10/738,881

(22) Filed: Dec. 17, 2003

(51) Int. Cl. A61H 3/02

(52) U.S. Cl. 135/72

(57) ABSTRACT

A portable device that is easily engageable with a stationary fitting in the home or in an automobile, and that is used to assist a person in an ambulatory transition such as lowering oneself from a standing position to a seated position in the home or in an automobile. In one embodiment, the device is reversibly engageable with a common U-shaped striker bar with which the latch mechanism of a car door engages.

This invention relates in one embodiment to a hand gripped assistance device that is used to assist a person in lowering himself from a standing position to a seated position or vice-versa, and more particularly to a portable device that is easily engageable with a stationary fitting in the home or in an automobile, and that is used to assist a person in lowering himself from a standing position to a seated position in the home or in an automobile.

### FIELD OF THE INVENTION

A portable hand gripped assistance device that is used to assist a person in lowering himself from a standing position to a seated position in the home or in an automobile.

### BACKGROUND OF THE INVENTION

It is well known that any person who is infirm, elderly, handicapped, temporarily ill, injured, or otherwise weakened may experience difficulty in raising himself up from a sitting position to a standing position, or in lowering himself from a standing position to a sitting position. The degree of difficulty of such a maneuver is partly a function of the environment; and specifically, whether or not such environment provides, either by happenstance or by design, any solid stationary object(s), which the person can grasp and use to assist himself in transitioning from a sitting to standing position, or vice-versa. The degree of difficulty is also a function of whether or not the person is also using any ambulatory assistance devices such as a scooter, a wheelchair, or a walker.

In many instances, the particular environment does not provide any suitable solid stationary object, which the person can grasp to assist in his ambulatory transition. For example, in an ambulatory transition from a vehicle, there is usually nothing suitable for the person to grasp. The vehicle door is movable, being hinged, rather than stationary. The vehicle body typically offers no stationary graspable object. In addition, the height of the vehicle seat may vary widely, from the largest sport utility vehicle to the smallest subcompact vehicle.

By way of a further example, in an ambulatory transition from a wheelchair or walker to a commode or bathtub, there is often not provided accommodations to assist in such a transition. The person's own bathroom may be equipped with a full set of “handicapped rails,” but when the person is a visitor in the bathroom of another, there is typically neither the time nor inclination to equip such bathroom with “handicapped rails” or other such accommodations. Moreover, many residential household bathrooms are not dimensionally or structurally suitable for the fitting of “handicapped rails.”

There is therefore a need for a device which provides an additional support function in an ambulatory transition, e.g. while egressing or ingressing from a motor vehicle. Such a device will eliminate or greatly reduce the tendency for instability while the person transitions from a standing to a seating position in the vehicle or vice versa. Such a device would ideally be a simple, light-weight, portable, reversibly engageable tool that would be functional across a range of vehicles, and would also be adaptable and useful in residential household applications. To the best of the applicant's knowledge, no such simple, light-weight, portable, reversibly engageable device or tool exists for the assistance of a person in an ambulatory transition.

It is an object of this invention to provide a light-weight, portable, reversibly engageable device for the assistance of a person in an ambulatory transition into and out of a vehicle.

It is an object of this invention to provide a light-weight, portable, reversibly engageable device for the assistance of a person in an ambulatory transition onto and off of a commode.

It is an object of this invention to provide a light-weight, portable, reversibly engageable device for the assistance of a person in an ambulatory transition into and out of a bathtub.

It is an object of this invention to provide a light-weight, portable, reversibly engageable device for the assistance of a person in an ambulatory transition, wherein such tool is collapsible to a compact shape.

It is an object of this invention to provide a light-weight, portable, reversibly engageable device for the assistance of a person in an ambulatory transition, wherein such tool is simply and reversibly attached to an ambulatory assistance device.

It is an object of this invention to provide a simple fitting, which can be retrofitted to a wall of a structure, such as a bathroom wall, and which is reversibly engageable with the devices of the present invention for assistance of a person in an ambulatory transition.

### SUMMARY OF THE INVENTION

In accordance with the present invention, there is provided an ambulatory transition assistance device that is reversibly engageable with a fitting, said ambulatory transition assistance device comprising a body having a proximal end, and a distal end; a grip at said proximal end for engagement with a human hand; and a first engagement means at said distal end for engagement with said fitting, wherein when said device is engaged with said fitting, rotational motion of said device with respect to said fitting is prevented in at least one direction in at least one plane of rotation of said device with respect to said fitting.

In accordance with the present invention, there is provided an ambulatory transition assistance device that is reversibly engageable with a fitting, said ambulatory transition assistance device comprising a body having a proximal end, and a distal end; a grip at said proximal end; and a first engagement feature at said distal end for engagement with said fitting, wherein when said device is engaged with said fitting, rotational motion of said device with respect to said fitting is prevented in at least one direction in at least one plane of rotation of said device with respect to said fitting.

The device of the present invention is advantageous because it provides a light-weight, portable, reversibly engageable means for a person to use in assisting with an ambulatory transition. As a result of the present invention, a handicapped, infirm, or temporarily injured or ill person can more safely execute an ambulatory transition into or out of a vehicle, or in an environment in a residential or public setting.

### BRIEF DESCRIPTION OF THE DRAWINGS

The invention will be described by reference to the following drawings, in which like numerals refer to like elements, and in which:

FIG. 1 is a perspective view of a typical striker assembly which is attached to the front door post and/or rear door post of most domestic and foreign motor vehicles currently sold;

FIG. 2A is a side view of one embodiment of a CEAD of the present invention wherein the body thereof is a unitary structure;

FIG. 2B is a perspective view of the CEAD of FIG. 2A;

FIG. 3A is a side view of another embodiment of a CEAD of the present invention wherein the body thereof is a laminated structure;

FIG. 3B is a cross-sectional view of the CEAD of FIG. 3A;

FIG. 4A is a side elevation view of the CEAD of FIGS. 3A and 3B, shown engaged with a typical striker plate assembly of FIG. 1;

FIG. 4B is a perspective view of the CEAD of FIGS. 3A and 3B, shown engaged with a typical striker plate assembly of FIG. 1, and gripped by a human hand;

FIG. 5A is another embodiment of a CEAD of the present invention comprising a formed grip for a more secure engagement with the human hand;

FIG. 5B is another embodiment of a CEAD of the present invention comprising an elongated grip for engagement with both hands at some point during the ambulatory transition;

FIG. 5C is another embodiment of a CEAD of the present invention comprising a curved body;

FIG. 5D is a side elevation view of another embodiment of a CEAD of the present invention comprising an engagement feature that, when engaged with a typical striker plate assembly of FIG. 1, is restrained from rotation in opposite directions;

FIG. 6 is a perspective view of a person using a CEAD of the present invention in an ambulatory transition;

FIG. 7A is another embodiment of an ambulatory transition assistance device of the present invention comprising a rod shaped end for engagement with a socket fitting;

FIG. 7B is a side sectional view of the device of FIG. 7A shown engaged with the socket fitting of FIG. 7A; and

FIG. 8 is a side view of another embodiment of a CEAD of the present invention wherein the gripping means at the distal end of the body thereof is a gripping loop.

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by the appended claims.

### DESCRIPTION OF THE PREFERRED EMBODIMENTS

For a general understanding of the present invention, reference is made to the drawings. In the drawings, like reference numerals have been used throughout to designate identical elements. In describing the present invention, a variety of terms are used in the description.

As used herein, an ambulatory transition is meant to include, without limitation, a transition made by a person from a sitting to a standing position; or from a standing to a sitting position; or from a reclining position to a sitting position; or from a sitting position to a reclining position; or from a standing position to a reclining position; or from a reclining position to a standing position; or from a first reclining position (e.g. face-down) to a second reclining position (e.g. face-up). For illustrative purposes, the description of the preferred embodiments of the present invention will be described in transitions from sitting to standing positions and vice versa, but such descriptions are not to be construed as limiting in the manner in which the present invention may be used in assisting a person in making ambulatory transitions. The term ambulatory transition is further meant to include transitions in series with other motions, and repetitive transitions, i.e. repetitive exercise.

As used herein, the abbreviation “ATAD” is an abbreviation for an ambulatory transition assistance device, used in making ambulatory transitions as recited in the immediately foregoing description.

As used herein, a Car Entry and exit Assistance Device (CEAD) will be described in various embodiments of the ambulatory transition assistance devices of the present invention. For illustrative purposes, the description of the Car Entry and exit Assistance Devices (CEADs) of the present invention will be described in transitions from sitting to standing positions and vice versa with respect to a vehicle but such descriptions are not to be construed as limiting in the manner in which a CEAD may be used in assisting a person in making ambulatory transitions in other environments in a residential or public setting. A CEAD may be used in such a setting in substantially the same manner as described for a vehicle, provided that a structural fitting is present in the environment similar to the fitting on a vehicle with which the CEAD is engaged during use thereof.

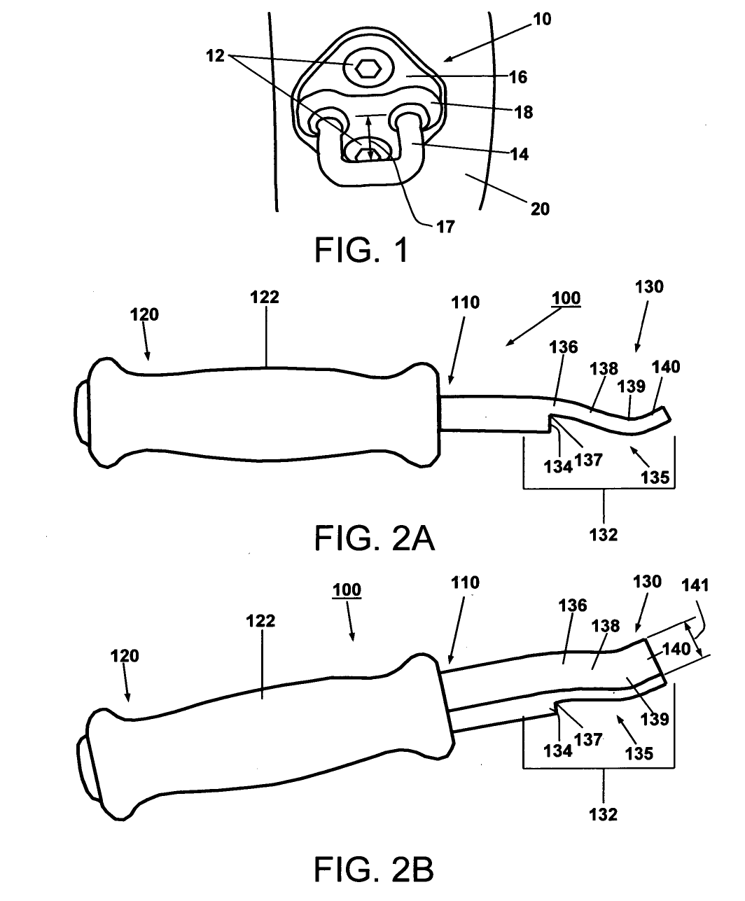

FIG. 1 is a perspective view of a typical striker assembly which is attached to the front door post and/or rear door post of most domestic and foreign motor vehicles currently sold. Although the many models of vehicles may use slight variations in materials and sizes, the general construction of the striker assembly is generally the same. Referring to FIG. 1, the striker assembly 10 is rigidly attached to the door post with heavy screws 12, and provides a firm support for the front or rear door which will be latched thereto when closed. The portion of the striker assembly with which the door latch is engaged is typically comprised of a U-shaped bar 14, which is joined to a mounting plate 16, preferably at a thickened reinforcement boss 18. Typically, mounting screws 12 are countersunk into plate 16.

Thus the striker assembly 10 acts to align and lock a car door to the car frame, and in particular, door post 20. A striker assembly is a strong structure that must be resistant to forces and bending moments from all directions. Such strength is required in order for the striker assembly to withstand forces that may occur in a crash or rollover. The strength requirements of a striker assembly are specified in various automotive engineering standards of the Society of Automotive Engineers, and are codified in government regulations, such as those issued by e.g., the National Highway Transportation Safety Administration (NHSTA) of the United States Department of Transportation. Thus a typical striker assembly, being of high structural strength, provides an ideal fitting with which to engage the CEAD of the present invention.

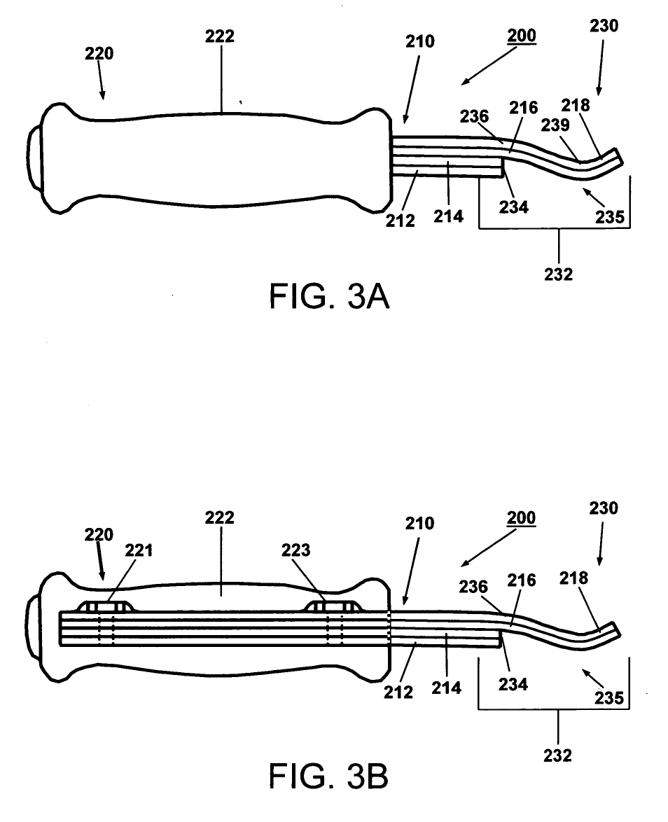

FIG. 2A is a side view of one embodiment of a CEAD of the present invention wherein the body thereof is a unitary structure, and FIG. 2B is a top view of the CEAD of FIG. 2A. Referring to FIGS. 2A and 2B, ambulatory assist device 100, or CEAD 100, comprises a body 110 having a proximal end 120 and a distal end 130. In the preferred embodiment, CEAD 100 is provided with gripping means comprised of a grip 122 that is formed along proximal end 120. In one embodiment, grip 122 is unitary with respect to body 110, i.e. body 110 is a solid single piece with grip 122 integrally formed therein. In a further embodiment, grip 122 includes individual recesses for each of the fingers formed therein.

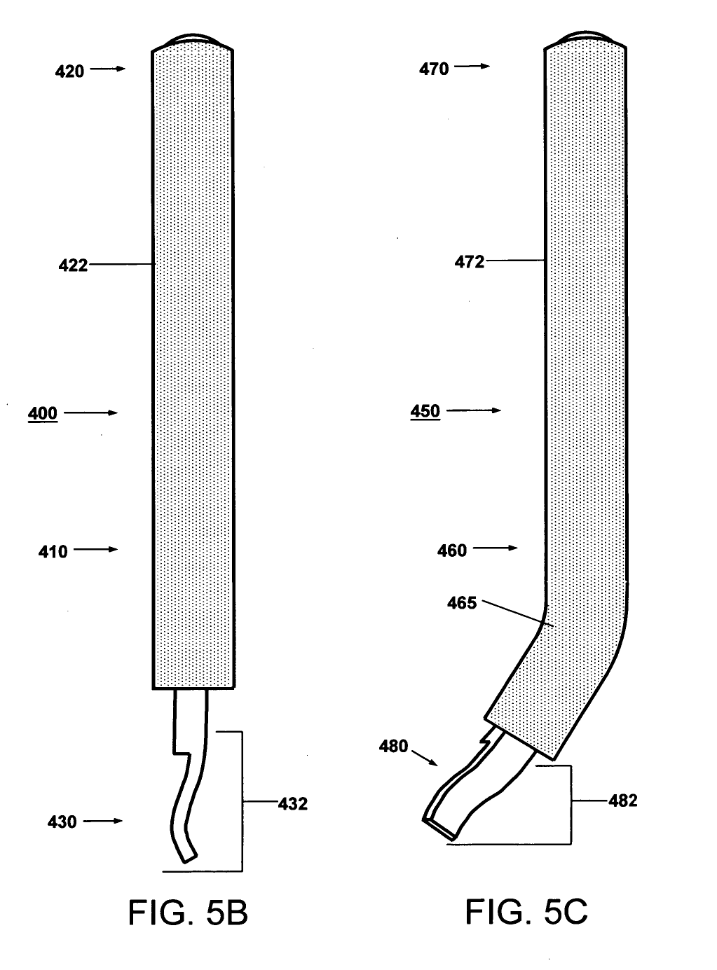

In the embodiment depicted in FIGS. 2A and 2B, grip 122 comprises a sleeve grip 122 encasing the proximal end 120 of body 110. In the embodiment depicted in FIGS. 2A and 2B, sleeve grip 122 comprises elastomeric foam, and preferably a closed-cell foam. Such a sleeve grip is typically used in applications where a soft compliant gripping surface is required for griping by a human hand. In another embodiment depicted in FIG. 5A, sleeve grip 122 comprises an elastomeric non-foam sleeve made of e.g. rubber or polyurethane, which is formed or comprised of a contour to match the shape of a human hand gripping thereupon.

Referring again to FIGS. 2A and 2B, body 110 of CEAD 100 further comprises a first engagement means at the distal end 130 of body 110, for engagement with a structural feature, such as a striker bar assembly 10 of FIG. 1. The details of engagement of the engagement means with a structural feature will be provided subsequently in this specification.

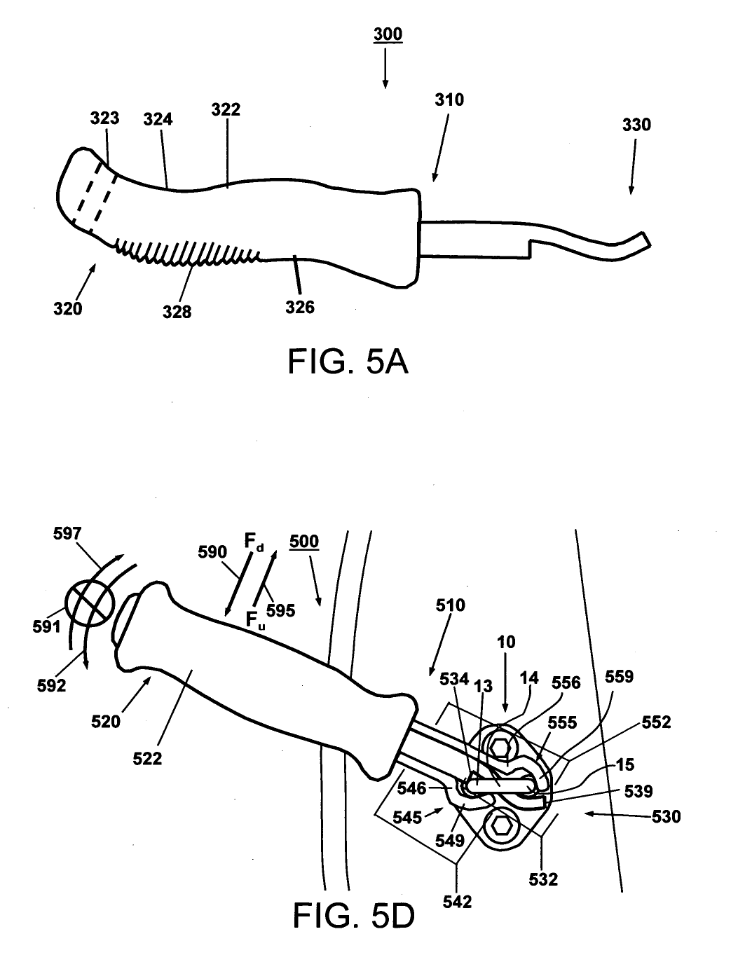

In the preferred embodiment, the engagement means of CEAD 100 of FIGS. 2A and 2B comprises engagement feature 132. Engagement feature 132 is preferably rectangular in cross-section, and preferably comprises a stepped edge 134 formed in body 110, and an engagement extension 135. In one embodiment, engagement extension 135 is simply a straight rectangular bar-shaped extension, extending beyond stepped edge 134. In the preferred embodiment, engagement extension 135 is formed with a first bend 136 preferably forming an acute angle 137 with stepped edge 134, an inner flat section 138, a second bend 139 disposed in the opposite direction of first bend 136, and an outer flat section 140. This preferred engagement extension 135 provides a superior engagement with the striker assembly 10 of FIG. 1 than the simple straight rectangular bar-shaped extension, as will be subsequently explained with reference to FIGS. 4A and 4B.

It is to be understood that acute angle 137 formed between stepped edge 134 and engagement extension 135 is meant over a dimensional distance on the order of as much as one-quarter of an inch. It will be apparent that for embodiments of the CEAD not comprising multiple leaves, but rather a solid structure of metal or plastic or a composite, it will be advantageous to provide a curved radius at the intersection of stepped edge 134 and engagement extension 135, rather than a sharp acute angled juncture 137 as depicted in FIG. 2A. Such provision of a radiused juncture is a well known method of distributing stress at a juncture to prevent cracking and failure of a part. Thus, as used herein, acute angle 137 is meant to include a radiused structure at the apex thereof, and such acute angle is determined as being formed by the overall profiles of stepped edge 134 and engagement extension 135.

In the embodiment depicted in FIGS. 2A and 2B, body 110 is substantially rectangular in cross section. In another embodiment (not shown), body I 10 has a substantially circular cross section. It will be apparent to those skilled in the art that bodies with other suitable cross-sections may be used, with the operative requirement being that such bodies have suitable structural strength for the intended ambulatory assistance use, and that such bodies are provided with the engagement means at the distal end 130 thereof.

CEAD 100 may be made of any material with sufficient structural strength to bear the loads applied thereupon during use thereof. In one embodiment, CEAD 100 is made of steel. In another embodiment, CEAD 100 is made of an aluminum alloy. In another embodiment, CEAD 100 is formed from a composite of carbon fiber and polymer resin. In yet another embodiment, CEAD 100 is formed from a composite of glass fiber and polymer resin, such as e.g., fiberglass reinforced polyester (FRP). In one preferred embodiment, CEAD 100 is formed from a material and structural combination such that CEAD 100 has some degree of flexibility, as will be described subsequently in this specification.

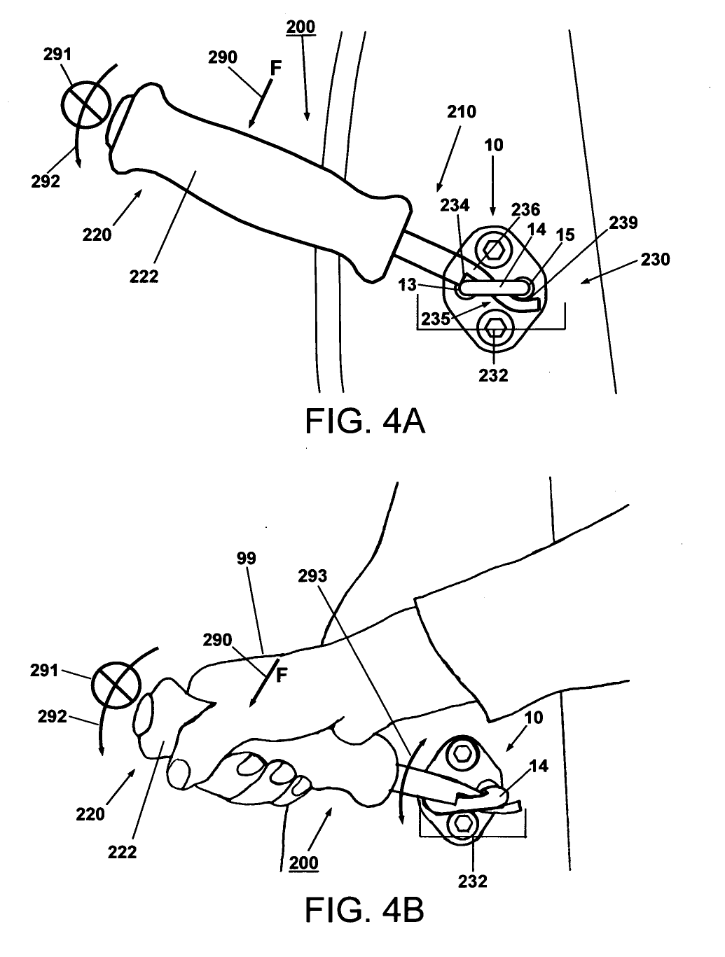

FIG. 3A is a side view of another embodiment of a CEAD of the present invention wherein the body thereof is a laminated structure, and FIG. 3B is a sectional view of the CEAD of FIG. 3A. Referring to FIGS. 3A and 3B, CEAD 200 is similar in structure to CEAD 100 of FIG. 2A, with the main difference being that body 210 and engagement feature 232 of CEAD 200 is comprised of a laminated structure of multiple layers 212, 214, 216, and 218 of material. In the embodiment shown in FIGS. 3A and 3B, CEAD 200 comprises four layers of material 212, 214, 216, and 218 in the central portion of the body 210 and the proximal end 220 that is enclosed by hand grip sleeve 222.

Layers 212 and 214 of body 210 terminate along body 210 to form stepped edge 234 of engagement feature 232 at distal end 230. Layers 216 and 218 extend outwardly from layers 212 and 214, and are formed into engagement extension 235, preferably with the same double-bent configuration as recited for engagement extension 135 of CEAD 100 of FIG. 2A.

The multi-layer laminated structure of body 210 of CEAD 200 of FIGS. 3A and 3B provides CEAD 200 with flexibility when CEAD 200 is engaged with a striker plate assembly such as striker plate assembly 10 of FIG. 1. The flexibility is a consequence of the multiple layered structure in that each of the layers may bend and spring back when the CEAD is in use. In particular, layers 216 and 218 formed in engagement extension 235 bend reversibly in the region proximate to bend 236. This bending action is well known in the mechanical arts; multilayered spring structures are widely used, such as e.g., leaf springs in automotive suspensions. In use, the overall structure of body 210 of CEAD 200 functions as a leaf spring comprised of leaves 212, 214, 216, and 218.

By providing such flexibility, CEAD 200 is capable of absorbing and recoiling if sudden forces are applied thereto during use thereof. This force absorbing capability prevents excessive shock loading of either the arm or shoulder of the patient using the CEAD, or the striker assembly of the vehicle, thereby greatly reducing the risk of twisting off, breaking off, or otherwise damaging the striker assembly. This also greatly reduces the possibility of having the grip 222 of CEAD 200 become unstable during the use thereof. In addition, if the striker assembly 10 is deformed or damaged, the door of the vehicle will no longer seat into the door frame properly, latch closed, and lock in place.

Without wishing to be bound to any particular theory, applicant believes that one important feature of the CEAD 200 of FIGS. 3A and 3B is that CEAD 200 is made to absorb some of the downward force, while the body 210 thereof is being used in the flexure of the construction of CEAD 200, and in the following “pinching” action of the CEAD 200 on striker plate assembly 10. This pinching action results in the striker unit 10 being compressed in a near horizontal orientation, which alleviates some of the twisting and downward forces which may apply if a rigidly constructed body 210 were used. Further details regarding the engagement of the CEAD with a striker assembly of a vehicle, and regarding various materials of construction of the CEAD are provided subsequently in this specification.

FIG. 3B is a sectional side view of the CEAD of FIG. 3A, comprised of a body having a laminated structure. Referring again to FIG. 3B, and in one preferred embodiment depicted therein, layers or leaves 212, 214, 216, and 218 are joined together in the central area and proximal end 220 by suitable fastening means such as rivets, or threaded fasteners 221 and 223, which are threadedly engaged with tapped holes in leaves 212, 214, 216, and 218. In other embodiments, and depending upon the particular materials of leaves 212,214, 216, and 218, such leaves may be joined by other suitable joining means such as e.g., spot welding, or by an adhesive.

FIG. 4A is a side elevation view of the CEAD of FIGS. 3A and 3B, shown engaged with a typical striker plate assembly of FIG. 1. Referring to FIG. 4A, the engagement means at the distal end 230 of CEAD 200 is engaged with striker assembly. Specifically, body 210 of CEAD is inserted through U-bar 14 of striker assembly 10, and engagement feature 232 is engaged with U-bar 14 such that stepped edge 234 is abutted against out-portion 13 of U-bar 14, and bend 239 is curled around out-portion 15 of U-bar 14.

With such an engagement, CEAD 200 is immobilized against striker assembly 10, and prevented from further insertion along the lengthwise direction of body 210. More importantly, such an engagement results in immobilization in the downward rotational direction. When a force F is applied to gripping means comprised of e.g., grip 222 of CEAD 200, as indicated by arrow 290, rotational motion of CEAD 200 in the direction indicated by arcuate arrow 292 is NOT permitted, as indicated by universal NOT symbol 291.

In addition, because the width of the engagement extension 235 is just slightly less than the gap 19 (see FIG. 1) between the striker boss 18 (see FIG. 1) and the inside edge of the striker U-bar 14 (see FIG. 1), CEAD 200 can not be rotated or otherwise moved laterally. In one embodiment, CEAD 200 is provided with an engagement extension 235 wherein such engagement extension 235 passes through gap 19 with a sliding contact fit. (For an understanding of the meaning of the width of the engagement extension 235, see FIG. 2B, wherein there is depicted a CEAD 100 with an engagement extension 140 having a width 141.)

By way of further illustration, FIG. 4B is a perspective view of the CEAD of FIGS. 3A and 3B, shown engaged with a typical striker plate assembly of FIG. 1 and gripped by a human hand. Referring to FIG. 4B, it can be seen that human hand 99 is applying a force F as indicated by arrow 290, but that rotation as indicated by arcuate arrow 292 is not permitted. In addition, because of the previously described fit of engagement extension 235 in striker assembly 10 (see FIG. 1), rotation of CEAD 200 in a plane other than the plane of rotation indicated by arcuate arrow 292 is also not permitted. Hence CEAD 200 is useful as a device for making an ambulatory transition into or out of a vehicle wherein CEAD 200 provides a resisting counterforce to force F, thereby allowing the user to steady himself and control his motion during the ambulatory transition.

By way of further illustration, and not limitation, in the embodiment depicted in FIG. 4B, CEAD 200 comprises a multilayered body 210 comprised of layers or leaves 212, 214, 216, and 218. (See FIGS. 3A-3B.) As described previously, this embodiment of CEAD 200 is provided with some flexibility, such that when CEAD 200 is suddenly loaded by a large force F, body 210 of CEAD 200 flexes and then recoils, as indicated by bi-directional arcuate arrow 293. Thus, sudden shock loadings to either the user's hand 99 or the striker assembly 10 are prevented by the absorption and release of such loads by CEAD 200.

As noted previously, the flexibility of CEAD 200 is a consequence of the multiple layered structure in that each of the layers may bend and spring back when the CEAD is in use. This bending action is well known in that multilayered leaf spring structures are widely used in applications such as e.g., automotive and recreational vehicle suspensions. For a further description of the structure, materials, and function of leaf springs, one may refer to e.g., U.S. Pat. No. 4,637,595 of Mishima et al, U.S. Pat. No. 4,508,325 of Marsh, U.S. Pat. No. 4,750,718 of Nickel, U.S. Pat. No. 3,968,958 of Huchette et al, U.S. Pat. No. 3,586,307 of Brownyer et al, U.S. Pat. No. 3,707,297 of Perreault et al, U.S. Pat. No. 1,814,682 of Frost, and U.S. Pat. No. 1,018,250 of McIntyre. The entire disclosures of each of these United States patents are incorporated herein by reference.

It is to be understood that CEAD 200 is not limited to a four-leaf structure, and that structures of more or fewer leaves are to be considered within the scope of the present invention.

In one embodiment, CEAD 200 of FIGS. 3A-4B was made with leaves 212, 214, 216, and 218 having a composition consisting essentially of aluminum alloy and having a width of 0.75 inches and a thickness of 0.125 inches. The overall length of this embodiment of CEAD 200 was approximately 8.4 inches. Grip 222 of CEAD 200 was made of a sleeve of closed cell rubber foam approximately 5 inches long and having an uncompressed thickness of between about 0.2 inches and 0.4 inches. One further embodiment of this CEAD 200 was made having leaves 212, 214, 216, and 218 of carbon steel. Another embodiment of this CEAD 200 was made having leaves 212 and 214 of carbon steel, and leaves 216 and 218 of aluminum alloy.

FIG. 5A is another embodiment of a CEAD of the present invention wherein the gripping means comprises a formed grip for a more secure engagement with the human hand. Referring to FIG. 5A, CEAD 300 comprises a body 310 having a proximal end 320 and a distal end 330. In the embodiment of FIG. 5A, a grip 322 is formed along proximal end 320. In one embodiment (not shown), formed grip 322 is unitary with respect to body 310, i.e. body 310 is a solid single piece, and grip 322, optionally including individual recesses for each of the fingers, is formed therein.

In the embodiment depicted in FIG. 5A, grip 322 comprises a molded or otherwise formed sleeve of rubber encasing body 310. Such a grip 322 is typically used in applications where a soft compliant gripping surface is required for gripping by a human hand. Grip 322 further comprises contoured surfaces 324 and 326 for better engagement of a hand therewith. In one embodiment, grip 322 is formed with at least a portion of the surface thereof having a plurality of nubs 328, which improve the tactile “feel” of such grip by the user thereof.

In yet a further embodiment, grip 322 is provided with a hole 323 therethrough at the proximal end of CEAD 300. Such a hole may be used to attach a quick-connecting clip (not shown) or retaining cord (not shown), so that the user may fasten the CEAD to another retaining feature provided on another ambulatory assist device such as a wheelchair, scooter, or walker (not shown).

FIG. 5B is another embodiment of a CEAD of the present invention comprising an elongated grip for engagement with both hands at some point during the ambulatory transition. Referring to FIG. 5B, CEAD 400 comprises a body 410 having a proximal end 420 and a distal end 430. In the embodiment of FIG. 5B, grip 422 is formed from proximal end 420 lengthwise along elongated body 410 to a point proximate to engagement feature 432. Grip 422 thus has sufficient room for the engagement of both hands by the user during an ambulatory transition.

In one embodiment, CEAD 400 of FIG. 5B was made with leaves 212, 214, 216, and 218 (see FIG. 3A) of aluminum alloy having a width of 0.75 inches and a thickness of 0.125 inches. The overall length of this embodiment of CEAD 400 was approximately 13.5 inches. Grip 422 of CEAD 400 was made of a sleeve of closed cell polyurethane foam approximately 10 inches long and having an uncompressed thickness of about 0.3 inches.

FIG. 5C is another embodiment of a CEAD of the present invention comprising a curved body. Referring to FIG. 5C, CEAD 450 comprises a body 460 having a proximal end 470 and a distal end 480. In the embodiment of FIG. 5C, body 460 of CEAD 450 is provided with a curved portion 465. When CEAD 450 of FIG. 5C is engaged with a striker assembly as depicted in FIG. 4A, curved portion 465 of CEAD 450 results in the grip 472 of CEAD 450 being disposed in a more angular direction with respect to the user's body (not shown). Depending upon the particular disability of the user, this provision may provide an easier ambulatory transition by the user.

In a further embodiment depicted in FIG. 5C, CEAD 450 is provided with an elongated grip 472, formed from proximal end 420 lengthwise along elongated body 410 to a point proximate to engagement feature 482. Grip 472 of CEAD 450 thus has sufficient room for the engagement of both hands by the user during an ambulatory transition.

In one embodiment, CEAD 450 of FIG. 5C was made with leaves 212, 214, 216, and 218 (see FIG. 3A) of aluminum alloy having a width of 0.75 inches and a thickness of 0.125 inches. The overall length of this embodiment of CEAD 450 was approximately 15 inches. Grip 472 of CEAD 400 was made of a sleeve of closed cell polyurethane foam approximately 10 inches long and having an uncompressed thickness of about 0.3 inches. CEAD 450 further comprised a bend 465 in the body thereof formed at an angle of about 150 degrees.

FIG. 5D is a side elevation view of another embodiment of a CEAD of the present invention comprising a first engagement means and a second engagement means, and preferably a third engagement means that, when engaged with a typical striker plate assembly of FIG. 1, is restrained from rotation in opposite directions. Referring to FIG. 5D, CEAD 500 comprises a body 510 having a proximal end 520 and a distal end 530. In the preferred embodiment, a grip 522 is formed along proximal end 520. CEAD 500 further comprises a first engagement means comprised of engagement feature 532, having a structure substantially the same as engagement feature 132 of CEAD 100 of FIG. 2A, and engagement feature 232 of FIG. 3A, both of which were previously described in this specification. As further described previously, first engagement feature 532 of CEAD 500, when engaged with striker plate assembly 10 as shown in FIG. 5D, prevents downward rotational motion if CEAD 500 as indicated by NOT symbol 591 and arcuate arrow 592.

Referring again to FIG. 5D, CEAD 500 comprises second engagement means comprised of engagement feature 542, and preferably third engagement means comprised of engagement feature 552. Engagement feature 542 is comprised of second engagement extension 545 extending downwardly and outwardly from body 510. Engagement extension 545 is preferably comprised of a first downward bend 546 bifurcating away from body 510 proximate to stepped edge 534, and a second bend 549 disposed in the opposite direction of first bend 546, such that second bend 549 wraps around at least the lower portion of out portion 13 of striker U-bar 14. Engagement feature 552 is comprised of third engagement extension 555 extending upwardly and outwardly from body 510. Engagement extension 555 is preferably comprised of a first upward bend 556 bifurcating away from body 510, and a second bend 559 disposed in the opposite direction of first bend 556, such that second bend 559 wraps around at least the upper portion of out portion 15 of striker U-bar 14.

In use, engagement feature 532 of CEAD 500 is inserted through U-bar 14 of striker assembly 10, and engagement feature 532 is engaged with U-bar 14 such that stepped edge 534 is abutted against out-portion 13 of U-bar 14, and bend 539 is curled around out-portion 15 of U-bar 14. As described previously, with such an engagement, CEAD 500 is immobilized against striker assembly 10, and prevented from further insertion along the lengthwise direction of body 510. Such an engagement results in immobilization in the downward rotational direction. When a downward force F_{d} is applied to grip 522 of CEAD 500, as indicated by arrow 590, rotational motion of CEAD 200 in the downward direction indicated by arcuate arrow 592 is NOT permitted, as indicated by universal NOT symbol 591.

In addition to preventing such downward rotation of CEAD 500, second engagement feature 542 and third engagement feature 552 prevent upward rotation of CEAD 500. Referring again to FIG. 5D, when CEAD is properly engaged with striker assembly as shown therein, second engagement feature 542 is engaged with U-bar 14 such that stepped edge 534 is abutted against out-portion 13 of U-bar 14, bend 549 is curled around and beneath out-portion 13 of U-bar 14, and bend 559 is curled around and above out-portion 15 of U-bar 14. Such an engagement results in immobilization of CEAD 500 in the upward rotational direction. When an upward force Fᵤ is applied to grip 522 of CEAD 500, as indicated by arrow 595, rotational motion of CEAD 200 in the upward direction indicated by arcuate arrow 597 is NOT permitted, as indicated by universal NOT symbol 591.

Hence CEAD 500 is useful as a device for making an ambulatory transition into or out of a vehicle wherein CEAD 500 provides resisting counterforces to both forces F_{d} and Fᵤ, thereby allowing the user to steady himself and control his motion during the ambulatory transition in either direction. This feature is particularly advantageous when making an ambulatory transition out of a vehicle that is low to the ground, such as from a sub-compact vehicle.

In a further embodiment (not shown), CEAD 500 comprises a first engagement means and a second engagement means disposed on opposite sides of body 510, wherein the first engagement means and the second engagement means are mirror images of each other. In this manner, the CEAD 500 may be engaged with the striker assembly 14 in either of two positions, i.e., there is no “up” or “down” orientation of the CEAD when positioning it to engage with the striker assembly 14. This embodiment of the CEAD is thus more easily engaged with the striker assembly 14, since the user thereof does not need to pay attention and specifically select a proper up/down orientation of the CEAD.

It will be apparent that the CEADs depicted in FIGS. 2A-5D are for illustrative purposes, and the relative angles of the grips of these CEADs with respect to the vehicles may vary, and yet still provide satisfactory results in the use thereof. This variation may be accomplished by e.g., varying the angle of the engagement feature with respect to the remainder of the body of the CEAD. In one embodiment, the angle of the grip may be substantially horizontal. In another embodiment, the angle of the grip may be substantially vertical. The optimal particular angle will vary depending upon the design parameters of the vehicle such as e.g., body height, striker assembly height, and seat height from the ground, and upon whether or not the CEAD is provided with a single engagement feature, or two engagement features that prevent rotation in either direction as described herein.

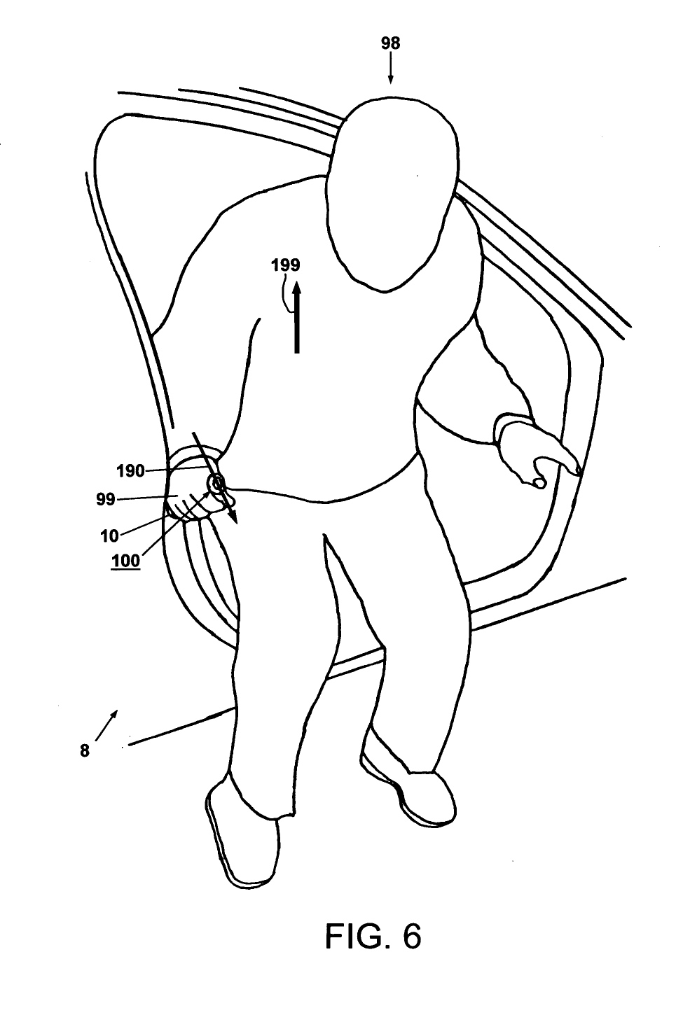

FIG. 6 is a perspective view of a person using a CEAD of the present invention in an ambulatory transition. Referring to FIG. 6, person 98 has engaged CEAD 100 with striker assembly 10 of vehicle 8, as described previously in this specification. Person 98 is gripping CEAD 100 in his hand 99 and applying a downward force as indicated by arrow 190, and as shown in FIG. 4B and described previously in this specification. CEAD 100 is providing a counterforce such that person 98 is using CEAD 100 to steady himself and also to assist his upward motion during his ambulatory transition as indicated by arrow 199.

In some circumstances, the CEADs of the present invention may be used by persons who are in a significantly weakened state, and/or persons who are obese. In such circumstances, particularly with the elongated CEADs 400 and 450 of FIGS. 5B and SC, it is possible that the force applied to a striker bar assembly of a vehicle by the CEAD may be sufficient to bend or break such striker bar assembly. To prevent such failure, in one embodiment, the CEAD is made of a material that yields (e.g., bends) at a level near to, but less than, the force required to damage the striker assembly. For example, in one embodiment, CEAD 200 of FIGS. 3A and 3B was made of aluminum alloy, which yielded slowly at a force less than that required to damage the striker assembly of the vehicle. This slow deformation provided a warning to the user to not apply further force to the CEAD.

In a further embodiment, the CEAD may alternatively or additionally be provided with a score mark cut into the engagement extension thereof thereupon to result in failure thereof prior to the sudden failure of the striker assembly of the vehicle. Such a score mark may be located e.g., at or near bend 136 of CEAD 100 of FIG. 2A. P In another embodiment, the CEAD of the present invention is provided with a lock-and-release hinge immediately adjacent to the inner end of the grip thereof, which renders the CEAD foldable like a jack knife. In yet another embodiment, the CEAD of the present invention is provided with a twist lock-and-release fitting immediately adjacent to the inner end of the grip thereof, which renders the CEAD collapsible by a telescoping action. Such fittings are well known in the fabrication of telescoping martial arts batons, walking sticks, and the like.

In a further embodiment, the grip of the CEAD is provided with a strip or a sleeve of loop material. Such loop material can be temporarily fastened to a corresponding piece of hook material, the pair of materials being the well known “hook and loop” or Velcro® joining material. Such hook material could be located in a convenient place for the user, such as e.g. the underside of a wheelchair armrest, so that the CEAD comprising a loop sleeve is easily secured there, yet very accessible for use.

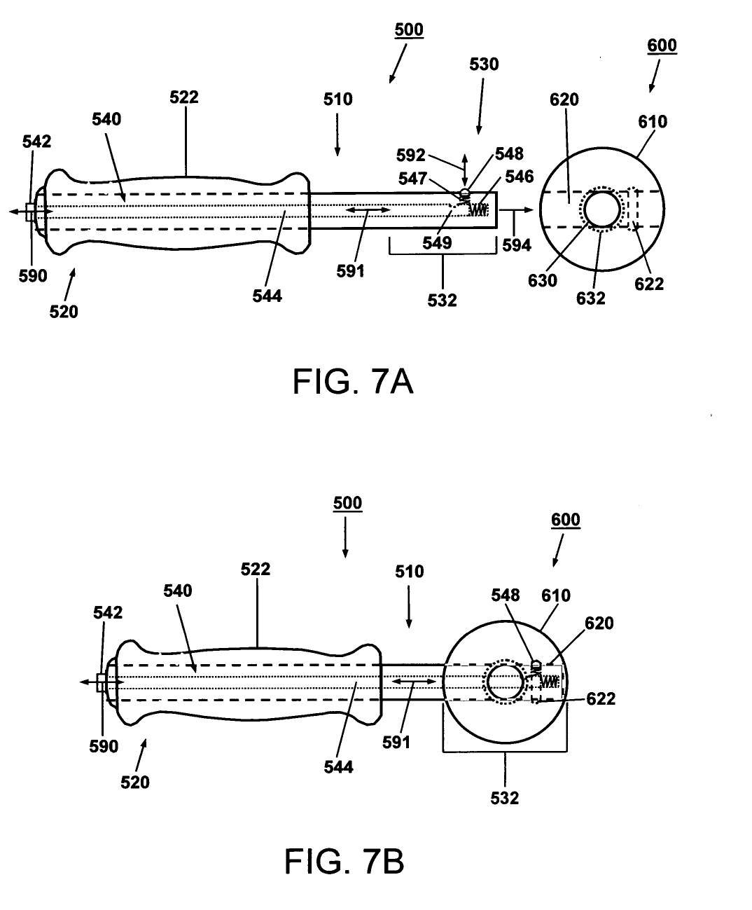

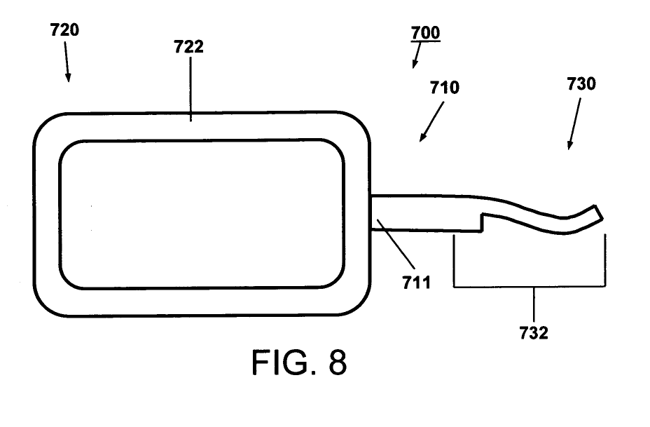

FIG. 8 is a side view of another embodiment of a CEAD of the present invention wherein the gripping means at the distal end of the body thereof is a gripping loop. Referring to FIG. 8, CEAD 700 comprises a body 710 comprising a grip 722 at the distal end thereof. Grip 722 is formed in a loop, and is joined to the central portion 711 of body 710, to form the overall body 710. By way of illustration, and not limitation, CEAD 700 is shown as having an engagement feature 732 having a structure that is substantially similar to engagement feature 132 of CEAD 100 of FIG. 2A. It will be apparent that CEAD 700 may alternatively comprise the structures of the engagement feature 232 of CEAD 200 of FIG. 3A, or the engagement feature 532 of ATAD 500 of FIG. 7A. It will be further apparent that loop grip 722 may be joined to the central portion 711 of body 710 at an angle other than that depicted in FIG. 8, with respect to engagement feature 732.

Loop grip 722 may be formed integrally with the rest of body 710, in such circumstances as when CEAD 700 is made of a moldable material such as a plastic, or a composite material. Alternatively, if CEAD 700 is made of metal such as aluminum or steel, loop grip 722 may be joined to the central portion 711 of body 710 by welding, or by a threaded fastener or fasteners (not shown).

Loop grip 722 may also be provided in shapes other than that depicted in FIG. 8, such as an elliptical shape, a D-shape, or a circular shape. Loop grip 722 is primarily intended to be engaged by the human hand, and thus a D-shape, an elliptical shape, or a rectangular shape with radiused corners are most suitable. In one embodiment, loop grip 722 is provided with a surface having peaks and valleys thereupon to match the shape of fingers of a hand, for a more secure engagement with a gripping hand.

In one embodiment, loop grip 722 is provided with an opening sufficiently large for the insertion of the lower portion of a human arm (or a prosthesis), up to approximately the elbow thereof. Loop grip may also provide an attachment location for the engagement thereof by a gripping mechanism of a prosthesis, or by a hook joined to a rope and/or pulley assembly and/or power assist means such as an electric motor, for assistance with an ambulatory transition. In one use, such rope and/or pulley assembly and/or power assist means may be engaged with the foot of the person making the ambulatory transition, instead of or in addition to the hand(s) of the person.

FIG. 7A is another embodiment of an ambulatory transition assistance device of the present invention comprising a rod-shaped end for engagement with a socket fitting; and FIG. 7B is a side sectional view of the device of FIG. 7A shown engaged with the socket fitting of FIG. 7A. Referring to FIGS. 7A and 7B, ambulatory transition assistance device (ATAD) 500 comprises a body 510 having a proximal end 520 and a distal end 530. In the preferred embodiment, gripping means comprising a grip 522 is formed along proximal end 520. In one embodiment (not shown), grip 522 is unitary with respect to body 510, i.e. body 510 is a solid single piece, and grip 522, optionally including individual recesses for each of the fingers, is formed therein.

In the embodiment depicted in FIGS. 7A and 7B, grip 522 comprises a sleeve of rubber foam encasing body 510. In another embodiment depicted in FIG. 5A, grip 122 comprises an elastomeric sleeve made of e.g. rubber or polyurethane, which is formed to match the shape of a human hand gripping thereupon.

Referring again to FIGS. 7A and 7B, body 510 of ATAD 100 further comprises an engagement means at the distal end 530 of body 510, for engagement with a structural fitting, such as socket fitting 600 of FIGS. 7A and 7B. In the preferred embodiment, the engagement means of ATAD 500 of FIGS. 7A and 7B comprises engagement feature 532. In one embodiment, engagement feature 532 comprises a taper formed along the distal end 530 of body 510.

The cross-bore 620 of socket fitting 600 is provided with a correspondingly tapered inner diameter, so that when tapered engagement feature 532 of ATAD 500 is inserted into socket fitting 600 as shown in FIG. 7B, a firm, snug fit therein is provided. Such a temporary mating of tapered parts is well known in e.g. the mating of chucks and arbors in machine tools. Alternatively or additionally, engagement feature 532 may be provided with fine splines around the circumference thereof, and cross-bore 620 may be provided with corresponding mating splines therein for a firm engagement of the ATAD 500 in the socket fitting 600.

In a preferred embodiment depicted in FIGS. 7A and 7B, the engagement means provided in the engagement feature 532 at the distal end 530 of ATAD 500 comprises a retractable retaining ball 548 fitted therein. In one embodiment (not shown) retractable retaining ball is simply spring loaded, and retracts when pressure is applied by a mating surface (such as socket bore 620) thereto. In a preferred embodiment depicted in FIG. 7A, retractable retaining ball is actuated by a quick release mechanism 540 comprised of push button 542, pushrod 544, spring 546, and spring 547. When pushbutton 542 is operated, as indicated by arrow 590, pushrod 544 is displaced correspondingly as indicated by arrow 591, with resulting contact of detent 549 against spring 547, which forces and releases ball 548 against the outer limit of the housing bore in which ball 548 is contained. Such a mechanism is known and is used e.g., for quick release of a socket that is temporarily joined to a ratcheting socket wrench.

To provide the most secure mating surface to engage with the engagement means comprising retaining ball 548, socket fitting 600 is provided with a groove 622 formed on the inner bore 620 thereof, so that when the engagement means of ATAD 500 is inserted into bore 620 as indicated by arrow 594, ball 548 is seated in groove 622 when pushbutton 542 is released. Thus ATAD 500 is securely held in socket fitting 600, until pushbutton 542 is depressed, and ATAD 500 is withdrawn.

Socket fitting 600 preferably comprises a short, cylindrical puck-shaped body 610. In one embodiment, cross bore 620 is provided completely through body 610. In another embodiment, cross bore 620 is only provided through a portion of body 610. In a further embodiment (not shown), a plurality of cross-bores are provided in body 610 disposed around the circumference of body 610. In a further embodiment depicted in FIG. 7A and 7B, socket fitting is further provided with an axial bore 630, for engagement with ATAD 500 along the central axis thereof. In the embodiment depicted in FIG. 7A, axial bore 630 is provided with a retaining groove 632 for engagement with retaining ball 548 of ATAD 500 as described previously.

In another embodiment (not shown), ATAD 500 is provided with at least one nub protruding from the engagement feature 532 thereof, and preferably, two nubs disposed on opposite sides of engagement feature 532. Socket 600 is provided with a pair of L-shaped grooves in the cross bore 620 and/or axial bore 630 thereof to receive the nub or nubs of engagement feature 532, when engagement feature 532 of ATAD 500 is inserted therein. A first leg of the L-shaped groove is disposed along the axial direction of such bore, and a second leg of the L-shaped groove is disposed along the circumferential direction of such bore.

Such an insertion of engagement feature 532 into bore 620 or 630 is first performed by inserting the engagement feature 532 into cross bore 620 or axial bore 630 with the nub or nubs sliding along the axial portion of the L-shaped groove(s), and then twisting the ATAD around its lengthwise axis such that the nub or nubs slide along the circumferential portion of the L-shaped groove(s). Such an insertion locks the ATAD firmly into the bore 620 or 630 of socket 600. This mechanism of engagement is known in e.g., the engagement of a light bulb in a light socket and is commonly used in automotive running lights.

It will be apparent that numerous other “quarter turn” mechanisms from the fastener arts and/or “quick disconnect” mechanisms from the plumbing and fluid handling arts will also be applicable to the engagement of the ATAD of the present invention with a socket.

It will be further apparent that ATAD 500 and socket fitting 600 may be provided with engagement features and bores having cross sections other than circular in shape, such as e.g., elliptical, square, or rectangular. For ease of manufacturing of ATAD 500 and socket fitting 600, such circular cross sections are preferred. ATAD 500 and socket fitting 600 may be manufactured of any materials having sufficient structural strength to withstand the forces applied thereto, such as e.g., steel, aluminum alloy, and high strength polymers and/or composites as described previously in this specification.

Socket fitting 600 may be adapted to be mounted on a variety of structures and locations where assistance in ambulatory transitions is beneficial, such as e.g., on exterior walls near doorways; on bathroom walls near commodes, bathtubs, or showers; and on the frame rails of beds and other patient supporting structures. The solid puck shaped structure of socket fitting 600 is well suited to provide tapped and/or smooth holes therein or therethrough for engagement and securing with a variety of threaded fasteners. In one embodiment, socket fitting 600 is joined to a sheet metal plate that is bent in a U-shape having a gap of the same dimension as a common 2×4 stud used in residential construction. The sheet metal plate is nested around the stud and fastened thereto by suitable means such as e.g. long deck screws. In using such an embodiment, socket fitting 600 may be installed in any location in a building where common stud and drywall construction is present.

In like manner, the striker assembly 10 of FIG. 1, that is used with the CEADs of FIGS. 2A-5D may be adapted to such indoor and outdoor installations on building walls. Thus the CEAD's of FIGS. 2A-5D may be used in applications other than ambulatory transitions into and out of vehicles.

It will be apparent that the structures of the various CEADs 5A, 5B, and 5C, comprising various grip shapes and/or materials, lengths, and bends may be adapted to the ATAD 500 of FIG. 7A. It will be further apparent that the ATAD 500 of FIG. 7A may be made foldable, and/or telescoping for improved portability as described previously. In a further embodiment, an ambulatory transition assistance device is provided with a first end having one of the engagement means previously described and shown in FIGS. 2A-5D, a second end having the engagement means shown in FIG. 7A, and a grip disposed along the body thereof between the first end and the second end.

It is, therefore, apparent that there has been provided, in accordance with the present invention, a device for the assistance of a person in an ambulatory transition. While this invention has been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the appended claims.

1. An ambulatory transition assistance device that is reversibly engageable with a fitting, said ambulatory transition assistance device comprising:
a. a body having a proximal end, and a distal end;
b. gripping means at said proximal end; and
c. a first engagement means at said distal end for engagement with said fitting, wherein when said device is engaged with said fitting, rotational motion of said device with respect to said fitting is prevented in at least one direction in at least one plane of rotation of said device with respect to said fitting.

2. The ambulatory transition assistance device as recited in claim 1, wherein said gripping means comprises a grip integrally formed in said body.

3. The ambulatory transition assistance device as recited in claim 1, wherein said gripping means comprises a sleeve grip encasing said proximal end of said body.

4. The ambulatory transition assistance device as recited in claim 3, wherein said sleeve grip is comprised of elastomeric foam.

5. The ambulatory transition assistance device as recited in claim 3, wherein the surface of said sleeve grip is comprised of a contour to match the shape of a human hand.

6. The ambulatory transition assistance device as recited in claim 1, wherein said gripping means comprises a loop grip.

7. The ambulatory transition assistance device as recited in claim 6, wherein said loop grip is D-shaped.

8. The ambulatory transition assistance device as recited in claim 1, wherein said first engagement means comprises an engagement feature having a rectangular cross-section.

9. The ambulatory transition assistance device as recited in claim 8, wherein said engagement feature comprises a stepped edge and an engagement extension.

10. The ambulatory transition assistance device as recited in claim 9, wherein said engagement extension comprises a first bend forming an acute angle with said stepped edge, an inner flat section, a second bend disposed in the opposite direction of said first bend, and an outer flat section.

11. The ambulatory transition assistance device as recited in claim 9, wherein said gripping means comprises a sleeve grip encasing said proximal end of said body.

12. The ambulatory transition assistance device as recited in claim 9, wherein said gripping means comprises a loop grip.

13. The ambulatory transition assistance device as recited in claim 1, wherein said body is comprised of a laminated structure comprised of at least a first leaf joined to a second leaf.

14. The ambulatory transition assistance device as recited in claim 13, wherein said first engagement means comprises an engagement feature having a rectangular cross-section.

15. The ambulatory transition assistance device as recited in claim 14, wherein said engagement feature comprises a stepped edge and an engagement extension.

16. The ambulatory transition assistance device as recited in claim 15, wherein said engagement extension comprises a first bend forming an acute angle with said stepped edge, an inner flat section, a second bend disposed in the opposite direction of said first bend, and an outer flat section.

17. The ambulatory transition assistance device as recited in claim 15, wherein said gripping means comprises a sleeve grip encasing said proximal end of said body.

18. The ambulatory transition assistance device as recited in claim 15, wherein said gripping means comprises a loop grip.

19. The ambulatory transition assistance device as recited in claim 13, wherein said laminated structure further comprises a third leaf and a fourth leaf joined to said first leaf and said second leaf.

20. The ambulatory transition assistance device as recited in claim 13, wherein said first leaf, and said second leaf consist essentially of aluminum alloy.

21. An ambulatory transition assistance device that is reversibly engageable with a fitting, said ambulatory transition assistance device comprising:
a. a body having a proximal end, and a distal end;
b. a grip at said proximal end; and
c. a first engagement feature at said distal end for engagement with said fitting, wherein when said device is engaged with said fitting, rotational motion of said device with respect to said fitting is prevented in at least one direction in at least one plane of rotation of said device with respect to said fitting.

22. The ambulatory transition assistance device as recited in claim 21, wherein said grip is integrally formed in said body.

23. The ambulatory transition assistance device as recited in claim 21, wherein said grip comprises a sleeve grip encasing said proximal end of said body.

24. The ambulatory transition assistance device as recited in claim 21, wherein said grip comprises a loop grip.

25. The ambulatory transition assistance device as recited in claim 21, wherein said first engagement feature has a rectangular cross-section.

26. The ambulatory transition assistance device as recited in claim 25, wherein said engagement feature further comprises a stepped edge and an engagement extension.

27. The ambulatory transition assistance device as recited in claim 26, wherein said engagement extension comprises a first bend forming an acute angle with said stepped edge, an inner flat section, a second bend disposed in the opposite direction of said first bend, and an outer flat section.

28. The ambulatory transition assistance device as recited in claim 25, wherein said grip comprises a sleeve grip encasing said proximal end of said body.

29. The ambulatory transition assistance device as recited in claim 25, wherein said grip comprises a loop grip.

30. The ambulatory transition assistance device as recited in claim 21, wherein said body is comprised of a laminated structure comprised of at least a first leafjoined to a second leaf.

31. The ambulatory transition assistance device as recited in claim 30, wherein said engagement feature has a rectangular cross-section.

32. The ambulatory transition assistance device as recited in claim 31, wherein said engagement feature further comprises a stepped edge and an engagement extension.

33. The ambulatory transition assistance device as recited in claim 32, wherein said engagement extension comprises a first bend forming an acute angle with said stepped edge, an inner flat section, a second bend disposed in the opposite direction of said first bend, and an outer flat section.

34. The ambulatory transition assistance device as recited in claim 32, wherein said wherein said grip comprises a sleeve grip encasing said proximal end of said body.

35. The ambulatory transition assistance device as recited in claim 32, wherein said grip comprises a loop grip.

36. The ambulatory transition assistance device as recited in claim 30, wherein said laminated structure further comprises a third leaf and a fourth leaf joined to said first leaf and said second leaf.

37. The ambulatory transition assistance device as recited in claim 30, wherein said first leaf, and said second leaf consist essentially of aluminum alloy.
